(19) United States
(12) Patent Application Publication
(10) Pub. No.: US 2025/0131758 A1
(43) Pub. Date: Apr. 24, 2025

(54) DOCUMENT PROCESSING USING MACHINE LEARNING

(71) Applicant: State Farm Mutual Automobile Insurance Company, Bloomington, IL (US)

(72) Inventors: Timothy John Husarik, Normal, IL (US); Jim Stehlik, Bloomington, IL (US); Rama Nrusimhadri, Allen Park, MI (US); Nathan Belete, Stone Mtn, GA (US); Alex Gataric, Normal, IL (US); Rini Sen, Bangalore (IN); Ashwani Bhati, Seoni Malwa (IN); Sameeh Ullah, Bloomington, IL (US); Ashok Kumar Chinni, Irving, TX (US)

(21) Appl. No.: 18/906,793

(22) Filed: Oct. 4, 2024

Related U.S. Application Data
(60) Provisional application No. 63/544,725, filed on Oct. 18, 2023.

(51) Int. Cl. G06V 30/41; G06F 40/279; G06V 10/82; G06V 30/18; G06V 30/19

(52) U.S. Cl. CPC G06V 30/41; G06F 40/279; G06V 30/18; G06V 30/19007; G06V 30/19147; G06V 30/1916; G06V 10/82

(57) ABSTRACT

Techniques for automatic intake and handling of the documents are discussed herein. A system may automatically classify a received document as image or text, and based on the classification, further process the document to determine a scene class for image documents, and a document category for a text document. In examples, the system may use trained machine-learning models for performing one or more tasks, and provide training data for training the ML models. Further, based on the document category and characteristics of the text, the system may determine and populate associated fields in insurance records with values from the document, and determine further processing actions and associated priorities.

### RELATED APPLICATIONS

This Patent Application is a nonprovisional of and claims priority to U.S. Provisional Patent Application No. 63/544,725, entitled “DOCUMENT PROCESSING USING MACHINE LEARNING,” filed on Oct. 18, 2023, the entirety of which is incorporated herein by reference.

### BACKGROUND

An insurance company may receive large numbers of unlabeled and uncategorized documents daily from different capture sources. These documents may include various types of documents, including photographs of property to be insured, photographs of damage, medical bills, repair estimates, repair bills, rental bills, police reports, and the like. The documents may be received from various sources, including customers of the insurance company, third-party claimants, a claim handler or other representative of the insurance company, vendors, and/or other sources. The documents may arrive by postal mail, as emailed attachments, as web uploads, from mobile apps, and/or via other mechanisms. Such documents may be manually processed to determine their association with existing insurance policies, claims and/or customers, extract information contained in the documents, determine prioritization and storage of the documents, and/or schedule actions to be taken in response.

In some situations, relevant information from the received documents may be populated into an enterprise claim processing system for record-keeping or further processing actions. For example, an estimated damage amount and a repair vendor's name and address may be extracted from a repair estimate and entered into appropriate fields of an insurance claim being processed, photographs of damage received with the repair estimate may be stored and the stored files linked to the insurance claim, and further steps in processing the insurance claim may be taken based on the received repair estimate.

However, manually categorizing received documents, entering information from the documents to a claim processing system, and handling document storage and management can be extremely time consuming and labor intensive given the large numbers of documents of various types that are received at an insurance company. This can lead to increased claim processing times overall caused by delays in attending to received documents, increased risk of misplaced or mis-categorized documents, and increased utilization of labor resources to extract information from the received documents to perform further actions.

The example systems and methods described herein may be directed toward mitigating or overcoming one or more of the deficiencies described above.

### SUMMARY

The present disclosure relates to automated document intake and processing, and more particularly, to automated categorization of documents, extraction of relevant information, and use of the information for actions related to a document processing system, such as an insurance document processing system, a medical document processing system, a financial document processing system, and the like. In an example of the present disclosure, a method includes receiving, by a processor, an electronic document, the electronic document including text data; extracting, by the processor and using text recognition, the text data from the electronic document; inputting, by the processor, the text data to a machine-learning (ML) model, wherein the ML model is trained to receive text data as input and to output a document category that corresponds to the input; receiving, by the processor, as output from the ML model and based at least in part on the text data, an indication of a particular document category corresponding to the electronic document; identifying, by the processor and based on the particular document category, a text segment of the text data, the text segment characterized by text features; determining, by the processor and based on the text features, a data field of a claim processing system corresponding to the text segment; and associating, by the processor, the text segment with the data field.

In another example of the present disclosure, a system is configured for receiving an electronic document including text data; extracting, from the electronic document and using optical character recognition (OCR), the text data; invoking a machine-learning (ML) model trained to determine a document category, wherein said invoking comprises: providing, as input, the text data to the ML model, and receiving, as output, a particular document category based on the text data; determining text features corresponding to a text segment of the text data; identifying, based on the particular document category, a set of pre-defined fields characterized by respective field features; determining, based on comparing the text features with the field features, a first field of the set of pre-defined fields, wherein the respective field features of the first field matches the text features; and associating with the text segment an identification of the first field.

In a further example of the present disclosure, a computer-readable storage medium storing computer-executable instructions, that when executed by a processor, cause the processor to: receive an electronic document; determine that the electronic document includes text data; extract, using text recognition, the text data from the electronic document; determine, using a machine-learning (ML) model trained to receive text data as input, and output a document category, a particular document category corresponding to the electronic document; identify, based on the particular document category, a set of data fields associated with the particular document category in a claim processing system; determine, based on text features, a text segment of the text data corresponding to a data field of the set of data fields; and associate the text segment with the data field.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 shows an example automated document processing system, as described herein.

FIG. 2 is a flow diagram illustrating an example process for automatically processing a received document.

FIG. 3 is a flow diagram illustrating an example process for populating fields in a digital record with values extracted from a document, as described herein.

FIG. 4 illustrates an example of associating text segments of a document with fields of a digital record, in accordance with examples of the disclosure.

FIG. 5 is a flow diagram illustrating an example process for training and refining a machine learning model for labeling text segments with field identifiers.

FIG. 6 shows an example system architecture for a computing device associated with an automated document processing system.

### DETAILED DESCRIPTION

This disclosure is directed to an automated document intake and handling system. The automated document intake system may be configured to prepare various types of received documents for automated processing, classify the documents into categories, and process the documents based on the determined category. For example, images (e.g., photographs) may be classified by scene and automatically labeled, and textual documents may be processed to extract meaningful text, and be further categorized based on the extracted text. The extracted text may be automatically populated into fields in existing or new digital records. The document handling system may determine next actions based on the categorization of the documents and information extracted from them.

In the following detailed description, references are made to the accompanying drawings that form a part hereof, and that show, by way of illustration, specific configurations or examples. The drawings herein are not drawn to scale. Like numerals represent like elements throughout the several figures (which might be referred to herein as a “FIG.” or “FIGS.”).

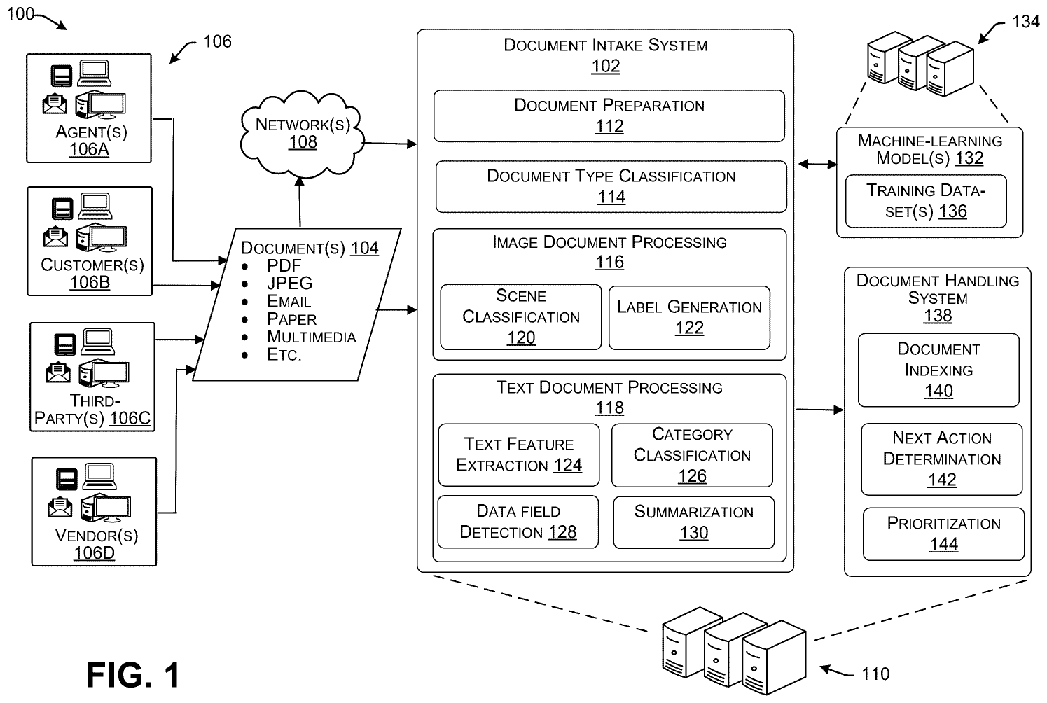

FIG. 1 shows an example automated document processing system 100 configured to receive and process documents of various types from a variety of sources. As shown in FIG. 1, a document intake system 102 may receive document(s) 104 from various sources 106. In examples, the sources 106 may include agents 106A of an enterprise, customers 106B of the enterprise, third-parties 106C, vendors 106D, and the like. As a non-limiting example, the enterprise may be an insurance company, and the agent(s) 106A may include insurance company representatives such as insurance agents, claim handlers, claims adjustors, customer assistance associates, call center representatives, operators, or other type of workers who have access to insurance policy origination, and claim or loss reporting tools of the insurance company. The customer(s) 106B of the insurance company may be individuals who hold an insurance policy, such as an automobile insurance, a fire/flood insurance, a life insurance, a home insurance, or other type of insurance, with the insurance company. In examples, the third-party(s) 106C may be individuals or attorneys representing individuals and/or businesses who want to file a claim for a loss incurred in an accident or other incident covered by an insurance policy of the insurance company. In some examples, the third-party(s) 106C may include law enforcement or government agencies (e.g., sources providing official documents or incident reports). The vendors 106D may include individuals or businesses providing services (e.g., vehicle and property repairs, vehicle rentals, hotel accommodations, medical treatments, etc.) related to an insurance claim to customers as well as other third-party individuals.

The sources 106 may send the document(s) 104 by a variety of means e.g., electronically via emails and/or attachments to emails, via file uploads on insurance company website(s), via apps running on a mobile device, as well as physically via postal mail or courier services. The document(s) 104 received electronically may be in various formats e.g., portable document format (pdf), image formats such as .jpg, .bmp, .tiff, .heic, etc., text formats such as plain text, rich text, Microsoft Word, etc., and multimedia formats such as .mov, .wav, .mp3/4, .mpeg, .avi, .wmv, etc. In examples, pdf and image formats may be used interchangeably for both images and text documents (e.g., picture of a text document captured by a digital camera/mobile device or a scanned pdf of an image document). In some examples, the document(s) 104 in electronic formats may be transmitted via network(s) 108 from the sources' 106 electronic devices to computing device(s) 110 implementing the document intake system 102. In some examples, the computing device(s) 110 may be computing devices of (e.g., internal servers) of the enterprise. In addition, some of the document(s) 104 may be hard-copy or paper documents received via physical mail, physical courier services, or other physical delivery mechanisms.

In examples, the document(s) 104 may include a wide variety of content. As non-limiting examples, the document(s) 104 may be image(s) (e.g., a photograph or video) illustrating property damage, image(s) illustrating property being insured (e.g., undamaged property at an origination of a new insurance policy covering the property), medical images such as x-rays, CT scans, MRIs, or other image(s) illustrating medical issues, image(s) illustrating accident scenes, image(s) illustrating natural disaster scenes, and the like. The property illustrated in the images comprising the document(s) 104 may be vehicles, homes, boats, or other types of property, and may show exteriors and/or interiors of the property. For example, the document(s) 104 may illustrate a room such as kitchen, living room, bedroom, or other room, exterior features of a residence, exterior and interior features of a vehicle, close-ups of dents or other damage, aerial views, and the like.

In some examples, the document(s) 104 may be primarily text-based. As non-limiting examples, the document(s) 104 may comprise an estimate or repair bill for repairing damage, a bill for towing or replacement vehicle rental, bills for medical tests or procedures, a report of an accident or damage (e.g., a first notice of loss (FNOL)), transcription of a voice call between an insurance agent and a caller related to a claim, a listing of items of value in a residence, and the like.

In some examples, the document(s) 104 may comprise a composite, multi-part document comprising images and/or textual content. As an example, the document(s) 104 may comprise an insurance claim document submitted by an attorney on behalf of an affected client (e.g., an “attorney demand package”). Such an attorney demand package may include various components, such as contact information of client and attorney, an introductory letter explaining an incident resulting in damages or injury, listing of damages to property and/or bodily injury with corresponding damage amounts demanded, receipts for bills paid by the client related to the damage and/or injury, police reports, medical reports, images supporting the claim, and the like. As another example, the document(s) 104 may comprise a hospital bill which includes components such as an itemization of various types of charges (e.g., ambulance charges, medication, medical tests, doctors' fees, surgical costs, room and board costs, etc.), medical images, charts illustrating patient's condition, doctors' reports, and the like.

In examples of the system 100, the document intake system 102 may include a document preparation component 112 and a document type classification component 114. The document preparation component 112 may implement techniques for converting the received document(s) 104 to standard format(s) for further processing. As an example, if the document(s) 104 is in paper form, the document preparation component 112 may electronically scan the document(s) 104 to generate a pdf version of the document(s) 104. As another example, if the document(s) 104 comprises an email with attachments, the document preparation component 112 may convert the email to a single document (e.g., a pdf file) containing a body of the email as a first page, and the attached documents appearing as subsequent pages. In yet other examples, the document preparation component 112 may convert image files to a standard format (e.g., JPEG) from other formats (e.g., .bmp, .tiff, .heic, etc.), process video files to extract keyframes and store the keyframes as image files, and process audio files using speech-to-text techniques to generate a text transcript.

Further, the document preparation component 112 may extract textual portions of the document(s) 104 in pdf format, originally or after conversion by scanning, using optical character recognition (OCR) techniques known in the art to generate a listing of text in the document(s) 104. In some examples, the document preparation component 112 may also process the listing of text using natural language processing (NLP) techniques known in the art to parse words, determine part-of-speech of the words including determination of proper nouns, sentences, paragraphs, and the like. In some examples, the document preparation component 112 may use generative artificial intelligence (generative AI) techniques and language models to understand content of the text in the document(s) 104 and/or extract portions of the text of high significance.

In examples, the document type classification component 114 may classify the document(s) 104 into an image document (e.g., “image type”) or a text document (e.g., “text type”). In some examples, the document type classification component 114 may comprise a first machine learning (ML) model or other artificial intelligence system configured to classify an input document as either an image type or a text type. As an example, the input may be pixels in an image of the document(s) 104, and the first ML model may be a convolutional neural network (CNN) trained to output either an “image type” or “text type” along with a probability score indicating a confidence level of the classification. The first ML model may be trained, via a supervised machine learning approach, using a training data-set containing numerous examples of documents of the text type and the image type. For example, the training data-set may comprise images of the documents, along with a ground truth label of the type associated with each document of the training data-set.

In another example, the document type classification component 114 may instead comprise a second ML model trained to determine whether an input is of an “image type” and a third ML model trained to determine whether an input is of a “text type.” The second ML model and the third ML model may each output a binary result (yes or no) indicating whether an input is of the respective type, and the document type classification component 114 may determine the type of the document(s) 104 as the output with a higher probability score. The second ML model and the third ML model may also be trained by a modification of the training data-set described above with respect to the first ML model. For example, in training data for the second ML model, the “image type” ground truth label may be replaced with “yes,” and the “text type” ground truth label replaced with “no,” while in the training data for the third ML model, the “text type” ground truth label may be replaced with “yes,” and the “image type” ground truth label replaced with “no.”

Alternatively, or in addition, in some examples, the document type classification component 114 may be based on the OCR output associated with the document(s) 104 generated by the document preparation component 112. For example, if a number of words detected in the document(s) 104 by OCR techniques is less than a threshold, the document type classification component 114 may classify the document(s) 104 as an “image type,” whereas, if the number of words is greater than the threshold, the document(s) 104 may be classified as “text type.”

In some examples, the document type classification component 114 may partition the document(s) 104 into first portion(s) of “image type” and second portion(s) of “text type” using image processing techniques. For example, the document type classification component 114 may sub-divide an image of the document(s) 104 into cells in a grid structure, and each cell may be classified into “image type” or “text type.” Further, the document type classification component 114 may merge neighboring cells of the same type to generate the first and second portion(s).

In examples of the present disclosure, the document intake system 102 may further process the document(s) 104 based on the output of the document type classification component 114. For example, an image document processing component 116 may process the document(s) 104 (or the first portion(s) of the document(s)) classified as “image type,” and a text document processing component 118 may process the document(s) 104) (or the second portion(s) of the document(s)) classified as “text type.”

In examples, the image document processing component 116 may include a scene classification component 120 and a label generation component 122. In some examples, the scene classification component 120 may comprise a fourth ML model configured as a multi-class classifier for a pre-defined set of semantic labels e.g., kitchen, bathroom, living room, building exterior, roof, automobile, boat, etc. In examples, the fourth ML model may be trained on a training data-set comprising numerous example images illustrating scenes corresponding to the pre-defined set of semantic labels, each tagged with respective semantic labels from the pre-defined set. In some examples, the pre-defined set may also include a catch-all label “other,” and the training data-set may include images labeled as “other,” to indicate that the respective image does not illustrate one of the pre-defined semantic labels.

In an alternative example, the scene classification component 120 may comprise a fifth ML model which may further comprise a set of ML models, each ML model of the set being trained to determine whether an input image corresponds to a particular semantic label of the pre-defined set. For example, a ML model of the set may be trained to determine whether the input image illustrates a kitchen, and may output a binary determination (yes or no) along with a probability or confidence score that the input image illustrates a kitchen. Such a ML model may be trained with a large number (e.g., thousands) of images of kitchens, as well as images not illustrating kitchens (e.g., labeled as “not kitchen”). In some examples, the images of the training set may include previously-received images illustrating scenes corresponding to one or more of the pre-defined set of semantic labels (e.g., extracted from insurance records of the insurance company).

In examples, the label generation component 122 may associate one or more labels with the document(s) 104. The labels may include the semantic label determined by the scene classification component 120, links to text documents (e.g., email, cover letter etc.) received along with the document(s) 104, date on which the document(s) was received, information identifying a source from which the document(s) 104 was received, links to existing insurance record (if known), and the like.

As discussed, in examples where the document(s) 104 is determined to be of a “text type” by the document type classification component 114, the document(s) 104 may be processed further by the text document processing component 118. In examples, the text document processing component 118 may include a text feature extraction component 124, a text category classification component 126, a data field detection component 128 and a summarization component 130.

The text feature extraction component 124 may process text content of the document(s) 104 (e.g., which may be original text received in digital form or an output of applying OCR techniques to the document(s) 104) to generate text features characterizing the text content. As an example, the text feature extraction component 124 may generate a bag-of-words (BoW) model characterizing the text content, which comprises a list of unique words in the document(s) and their respective frequency (e.g., a number of times the word occurs) in the document(s) 104. In some examples, the BoW model may include bigram and trigram frequencies. In examples, frequent words in a language of the document(s) 104 which are not semantically meaningful (e.g., “stop words” such as a, an, the, is, and, so, etc. in English) may be removed before computing the BoW model. In other examples, the text feature extraction component 124 may instead generate, as text features, an entirety of the text content of the document(s) 104 after removal of stop words.

In some examples, the text feature extraction component 124 may generate, as text features, words included in a pre-defined list of significant words only. For example, the pre-defined list may include words relevant to insurance claims and policies such as “estimate,” “damage,” “amount,” “maximum,” “rental,” “repair,” “vehicle,” “warranty” etc., phrases such as “amount due,” “due date,” “for your approval,” etc., as well as segment(s) of text corresponding to proper nouns, addresses, dates, numbers (e.g., dollar amounts indicated by “$”), etc., and groupings such as “amount due” followed by a dollar amount, a “due date” followed by a date, a proper noun (e.g., name of business) followed by an address, and the like. In some examples, the pre-defined list may be based on the document category. For example, a pre-defined list corresponding to a document category “repair bill” may include a “vehicle make/model” field (e.g., “2017 Toyota Camry”), “repair shop (or vendor) name” field, “vehicle parts” (e.g., “brake,” “front bumper,” “tail light,” etc.

In some examples, the text feature extraction component 124 may associate other features with words in the document(s) 104, such as a location of the word on a page, neighboring words, whether the word is numerical (e.g., a number), whether the word is a date, whether the word is a or part of an address, and the like. As an example, the text feature extraction component 124 may generate only words included in the pre-defined list along with respective locations of the words on the page.

The category classification component 126 may classify the document(s) 104 as belonging to a document category, from a pre-defined set of document categories, based on the text features generated by the text feature extraction component 124. In some examples of the present disclosure, there may be over a hundred categories in the pre-defined set of document categories e.g., a repair estimate, repair bill, medical bill, medical treatment estimate, police report, cover letter, tow bill, rental reservation, rental bill, hotel bill, and the like.

In examples, the category classification component 126 may comprise a sixth ML model further comprising a bank of ML models, each ML model of the bank trained to determine whether text features provided as input correspond to a specific category of the pre-defined set of document categories. For example, a ML model of the bank may be configured to output a binary determination of whether the input text features correspond to a “repair estimate” category (yes or no). In such examples, the number of ML models in the bank of ML models may be equal to the number of pre-defined document categories in the set. Each ML model in the bank may also output a probability or confidence score indicating a likelihood that the input corresponds to the respective document category.

In examples, the category classification component 126 may provide the text features generated by the text feature extraction component 124 from the document(s) 104 as input to the sixth ML model, and receive, as output, confidence scores corresponding to each ML model of the bank of ML models. As a non-limiting example, the document(s) 104 may be a “repair estimate” with a confidence score of 0.6, a “repair bill” with a confidence score of 0.8, a “police report” with a confidence score of 0.1, and so on, for each of the pre-defined set of document categories. The category classification component 126 may determine the document category of the document(s) 104 as the document category corresponding to the ML model of the bank of ML models with a highest probability or confidence score. In other examples, the category classification component 126 may compare the probabilities with a threshold, and determine the document category of the document(s) 104 as the category with a probability higher than the threshold. In some examples, if there are more than one category with a probability higher than threshold, the category classification component 126 may determine that the document category of the document(s) 104 is not certain, and accordingly, may assign an “undetermined” document category to the document(s) 104.

In alternative examples, the category classification component 126 may comprise a seventh ML model which may be a multi-class classifier configured to generate any output category from the pre-defined set of document categories, along with a probability corresponding to the output category or output probabilities corresponding to each of the pre-defined set of document categories. In some examples, the seventh ML model may be multi-class classifier configured to generate one of a subset of the pre-defined set of document categories, and the category classification component 126 may comprise a combination of the seventh ML model providing multi-class classification for the subset, and the sixth ML model providing single category classification other document categories, not included in the subset, in the set of document categories.

In examples, the sixth and the seventh ML models may be trained using a training data-set comprising large numbers of examples of documents in each of the pre-defined set of document categories, each data point of the training data-set being labeled with the respective document category. The training data-set for each ML model of the bank of ML models of the sixth ML model may include the same documents, with documents matching the category of the ML model being labeled “yes” and the other documents (e.g., of other categories that do not match) being labeled “no,” indicating an expected output of the respective ML model. Whereas, the seventh ML model may use the label indicating the document category as an expected output during the training phase. The documents of the training data-set may be processed to generate the same text features as will be used to process the document(s) 104 e.g., by processing the documents of the training data-set by the text feature extraction component 124. During a training phase, parameters (e.g., weights) of the ML models may be tuned using a supervised learning algorithm till a threshold level of performance (e.g., percentage of correct output) is reached on the respective training data-set.

The data field detection component 128 may process the text content of the document(s) 104 to detect segment(s) of text in the document(s) 104 corresponding to data field(s) in insurance claims, loss reports, or policy record(s) in a claim processing system of the insurance company. In examples, each document category may be associated with a pre-defined list of category-specific fields, which may potentially be present in a document of the particular category. In examples, the data field detection component 128 may determine a correspondence between the segment(s) of text of the document(s) 104 and one or more fields of the list for the respective document category. For example, a document category “repair estimate” may be associated with a list of fields comprising name of repair shop, address of repair shop, make/model of damaged vehicle, name of owner of the vehicle, dollar amount of the estimate, date of the estimate, etc. In some examples, the data field detection component 128 may tag the detected segment(s) of text with its corresponding field(s) by using pre-defined identifiers corresponding to the fields.

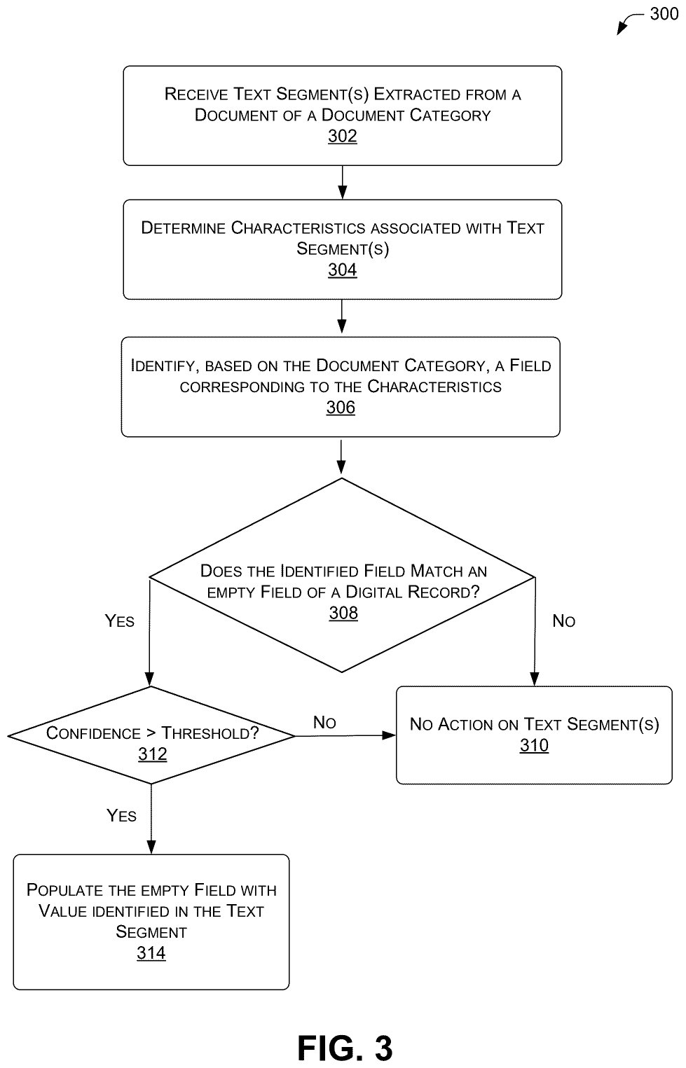

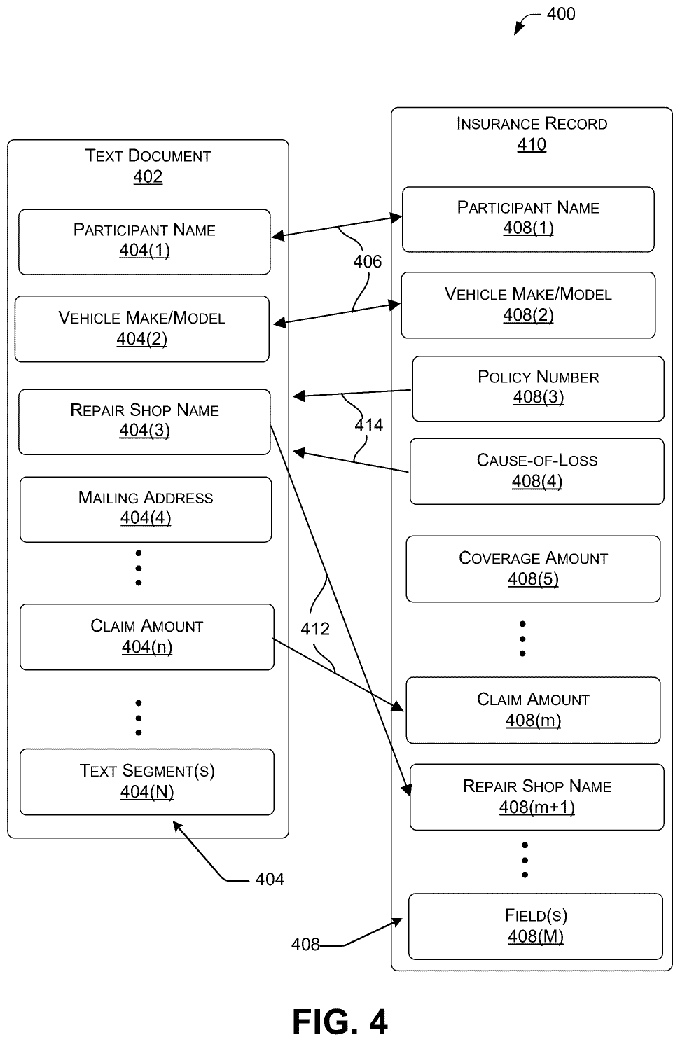

The data field detection component 128 may comprise an eighth ML model trained to output identifiers corresponding to fields when provided the text content and/or text features of the document(s) 104. In some examples, the data field detection component 128 may comprise a rule-based classifier, a decision tree, an instance-based classifier, a statistical classifier, or other pattern classifiers known in the art. The eighth ML model or the other pattern classifier may also output a probability or confidence score indicating a confidence level of the association between a text segment and a corresponding field. In some examples, the data field detection component 128 may compare characteristics of the text segment(s) (e.g., alphabetical or numerical, whether a proper noun indicating a person's name, street name, or city, value range of numerical segment(s) such as under 100$, 100-500$, 500-1000$, over 1000$, and/or other values ranges) with expected characteristics of the field to determine a match. The data field detection component 128 is described in further detail with reference to FIGS. 3 and 4. In some examples, the data field detection component 128 may identify an existing insurance record (e.g., an insurance policy, an insurance claim, a loss report, etc.) based on one or more values of the fields identified in the text segment(s) and automatically populate unfilled fields of the insurance record if the confidence score is higher than a threshold confidence level. In some examples, the data field detection component 128 may add additional fields to the insurance record (e.g., a “comment” field, or a “customer preference” field, etc.) to capture additional information present in the document(s) 104.

The summarization component 130 may generate a summary of the text contents of the document(s) 104. In some examples, the summarization component 130 may generate the summary based on the segment(s) of text and their corresponding field, as generated by the data field detection component 128. In the example “repair estimate” document described above, the summary may indicate values corresponding to the fields in the list of fields. In some examples, the summarization component 130 may perform computations on the values corresponding to the fields to determine other values to be included in the summary. For example, the summarization component 130 may compute a total amount claimed (e.g., sum total of an itemized list of claimed amounts), difference between a maximum coverage amount and a claimed amount (e.g., to ascertain that the maximum coverage amount is not exceeded), etc. Additionally, the summarization component 130 may add descriptive tags to the document(s) 104 indicating relevant information such as a participant name or a policy number associated with the document(s) 104, date the document(s) 104 was received, a document category of the document(s) 104, and the like. In some examples, the summarization component 130 may use generative AI techniques such as large-language models (LLMs) to determine a summary of the text contents of the document(s) 104.

In examples where the document(s) 104 comprises a multi-part document such as an attorney demand package or a hospital billing report, the summarization component 130 may generate a table-of-contents for the document(s) 104. For example, the table-of-contents may list the document type and/or document category corresponding to components of the document(s) 104 along with links or bookmarks to a page number (e.g., in a pdf file) and a summary of content of the respective component. For example, the table-of-contents for an attorney demand package may indicate that a text document of category “cover letter” is on page 1, images of scene class “automobile” are on pages 2-6, text documents of category “repair bills” are on pages 7-9, text documents of category “medical bills” are on pages 10-11, and an image of scene class “medical image-X-ray” is on page 12 of the document(s) 104. Further, the table-of-contents may summarize field values associated with each of the component(s) of “text type,” and labels associated with each of the component(s) of “image type.” The summarization component 130 may also include computed values based on the field values in the summary of content e.g., a sub-total of medical bills, a sub-total of property damage, a sub-total of rental charges, etc.

As shown in FIG. 1, ML model(s) 132 corresponding to the various ML models described with respect to the components of the document intake system 102 (such as the first ML model, the second ML model, the third ML model, the fourth ML model, etc.) may be hosted on a computing device 134 (e.g., an external or cloud-based server) separate from the computing device(s) 110 in some examples, and may be accessible to components on the computing device 110 via the network(s) 108. In examples, one or more of the ML models 132 may be implemented as artificial neural networks (ANNs), including convolutional neural networks (CNNs), recurrent neural networks (RNNs), generative adversarial networks (GANs), transformer-based models, residual neural networks (ResNet), or other neural network architectures such as DenseNet, PointNet, and the like.

As described herein, an exemplary neural network is an algorithm that passes input data through a series of connected layers to produce an output. Each layer in a neural network may also comprise another neural network, or may comprise any number of layers (which may be convolutional layers). As may be understood in the context of this disclosure, a neural network may utilize machine learning, which may refer to a broad class of such algorithms in which an output is generated based on parameters learned during a training phase.

Although discussed in the context of neural networks, any type of machine learning technique may be used to implement one or more of the ML model(s) 132. For example, the ML models 132 may include, but are not limited to, regression models, instance-based models, decision tree models, Bayesian models, support vector machines (SVMs), nearest neighbor classifiers, Radial Basis Function (RBF) models, etc. trained by supervised learning, unsupervised learning, or semi-supervised learning algorithms. As another example, the ML model(s) 132 may include transformer-based models comprising an encoder component mapping an input to a high-dimensional embedding space, and a corresponding decoder component.

In some examples, the ML models 132 may be trained on training data-set(s) 136 using a supervised machine learning approach. For example, the training data-set(s) 136 may include numerous data points corresponding to documents from previous insurance records, including documents from previous loss reports, documents from claims, documents from insurance policies, and the like. Each document in the training data-set(s) 136 may be tagged with one or more of a document type (image or text), scene class, image label, document category, text segments corresponding to fields, summaries etc., to train one or more of the ML models 132 described above. In some examples, the documents of the training data-set(s) 136 may be tagged manually, whereas in other examples, tags may be generated automatically or semi-automatically. In examples, the document(s) 104 received by the document intake system 102 may be provided to the computing device(s) 134 for use as data points of the training data-set(s) 136.

In examples of the system 100, a document handling system 138 may process the document(s) 104 based on determinations made by the document intake system 102. In examples, the document handling system 138 may include a document indexing component 140, a next action determination component 142, and a prioritization component 144. In some examples, the document handling system 138 may also be implement on the computing device(s) 110 implementing the document intake system 102.

The document indexing component 140 may add the document(s) 104 to index tables to enable efficient retrieval of the document(s) 104 from its file storage locations in response to queries. In some examples, the document(s) 104 may be stored in databases based on the document type and/or document category. For example, images may be stored in an image database, bills may be stored in a database used for issuing payment, etc. In examples, the document indexing component 140 may index the document(s) 104 by associating the document(s) 104 to participants of insurance policies, policy records, cause-of-loss, and the like, enabling a user of the system 100 to find the document(s) 104 by querying using a participant name, policy number, and/or cause-of-loss. Additionally, the document indexing component 140 may determine restrictions on viewability and access of the document(s) 104 based on the document type, document category and/or source of the document(s) 104. As non-limiting examples, the document indexing component 140 may make the document(s) 104 viewable to external entities that are a source of the document(s) 104, the document(s) 104 of document category “police report” may not be accessible to external entities, the document(s) 104 containing personal information (e.g., social security number, birthdate, bank accounts etc.) may be accessible to a limited set of users of the system 100, the document(s) 104 of category “repair bill” or “medical bill” may be accessible to claims adjusters of the insurance company, and the like.

In examples, the next action determination component 142 may determine processing action(s) to be taken based on the document type, document category, and/or content of the document(s) 104. The processing action(s) may include automated action(s) as well as routing of the document(s) 104 to appropriate users of the system 100 for further actions. As non-limiting examples, the next action determination component 142 may route link(s) to the document(s) 104 corresponding to a “bill” category to claim handlers responsible for approving payments, determine the processing action(s) as action(s) that were awaiting receipt of the document(s) 104, route link(s) to the document(s) 104 to appropriate claim handlers based on cause-of-loss, type of insurance policy (e.g., auto, home, fire, medical, etc.), route link(s) to the document(s) 104 from legal entities to legal entities of the insurance company, and the like. In some examples, the next action determination component 142 may determine processing action(s) to be taken based on detected values in the document(s) 104 corresponding to fields. For example, if an amount is less than a threshold amount, the document(s) 104 may be forwarded for automatic payment, whereas, if the amount is higher than the threshold amount, the document(s) 104 may be forwarded for further review by a claim handler.

In some examples, the next action determination component 142 may, based on determining that the document(s) 104 is a multi-part document (e.g., of a document category such as “attorney demand package” or “hospital bill”), separate the document(s) 104 into its component documents, and determine a next processing action for each component document. Other non-limiting examples of a next processing action may include sending an automated reply (e.g., text, email, notification to app, etc.) in response to receiving and processing the document(s) 104, adding information related to the document(s) 104 (e.g., document category, text segments corresponding to fields, data of receipt, etc.) to notes associated with an insurance record, requesting authorization for performing an action (e.g., issuing payment), assigning the document(s) 104 to a claim adjuster or insurance group, adding an indication of the next processing action taken to a record or dashboard, and the like.

In examples, the prioritization component 144 may determine a priority of the document(s) 104 and associate the document(s) 104 with a priority score to enable claim handlers to search and access the document(s) 104 by their priority. In examples, the priority score may be based on business rules. For example, the document(s) 104 comprising images of a home or vehicle for origination of an insurance policy may be assigned a low priority indicating that there is no urgency in acting on the document(s) 104. As another example, the document(s) 104 of the category “bill” may be assigned a high priority as payments need to be processed within a prescribed timeframe in response to receiving the document(s). In some examples, the priority of the document(s) 104 of the category “bill” may be based on a value of a “due date” field e.g., if the due date is closer to current date, the document(s) 104 may be assigned a higher priority.

As described above with respect to FIG. 1, the system 100 may receive document(s) of various types from various sources, and process the document(s) based on a type and/or category which may be determined by trained machine-learning models. Text segment(s) in the document(s) corresponding to fields in insurance records may be extracted and automatically populated in the insurance records, and the document(s) may be further handled based on the type, category and/or values of the fields.

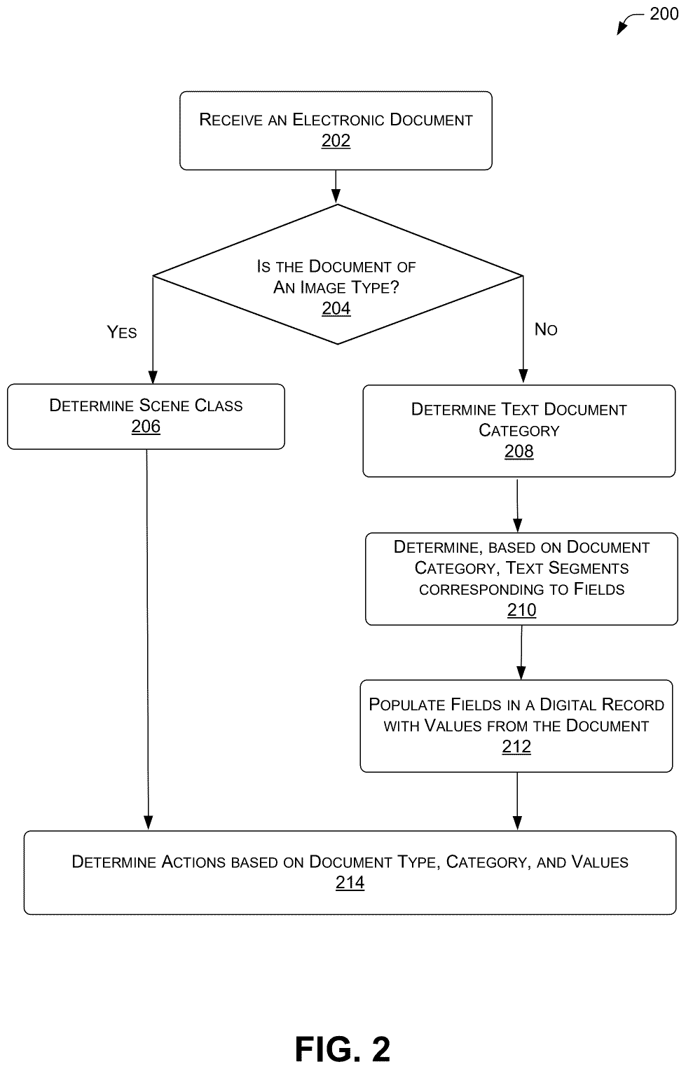

FIG. 2 depicts an example process 200 for automatically processing received document(s), in accordance with examples of this disclosure. For example, some or all of the process 200 may be performed by one or more components in FIG. 1, e.g., the components of the document intake system 102 and/or the components of the document handling system 138.

At operation 202, the process 200 may include receiving an electronic document. The received document may be in a standard format (e.g., jpeg or pdf) obtained by scanning and/or converting an original document e.g., by the document preparation component 112. In examples, the document may be received from an agent, customer or vendor of an insurance company or a third-party and be related to an insurance claim, an insurance policy, a loss report, etc. In some examples, the document may be received over a computer network from a mobile app, email, web upload, etc.

At operation 204, the process 200 may include identifying if the document is of an image type. As discussed above with respect to FIG. 1, the document may be classified as an image type or a text type by using a trained machine-learning (ML) model configured to output a document type along with a confidence score, or separate trained ML models each configured to determine one of an image type or a text type, and generate a confidence score of the determination. If the document is classified as image type (at 204—Yes), the process 200, at an operation 206 may further determine a scene class of the document. As described, the scene class may be determined by a multi-class, trained machine-learning model or a set of ML models each configured to identify a single scene class. In examples, a set of scene classes may be pre-defined, which may include, as non-limiting examples, rooms in residences such as kitchen, bathroom, bedroom etc., vehicles, medical images, aerial views of damage to property, etc. The ML model may also output a probability or confidence score of the determination of the scene class. In some examples, the process 200 may determine the scene class based on the probability of the scene class being higher than a threshold, and assign an “undetermined” scene class if the probability is less than the threshold or if more than one class has a probability higher than the threshold. In some examples, if the document is assigned an “undetermined” category, it may be forwarded for manual processing.

If the document is determined to be of text type (at operation 204-No), the process 200, at an operation 208, may determine a category corresponding to the document. As described, an insurance company may receive text documents of over one hundred categories. The process 200 may determine the category from a pre-defined set of categories using trained machine-learning model(s) e.g., “repair estimate,” “medical bill,” “repair bill,” “rental bill,” “police report,” “attorney demand package” etc. In some examples, the ML model may be a multi-class classifier that receives, as input, text content or text features of the document, as described above, and output the document category along with a confidence score indicating a confidence level of the output. In other examples, the process 200 may use a bank of trained ML models, each configured to output a binary determination (yes or no) that the input text content or text features correspond to a specific document category, along with a confidence score. In some examples, the process 200 may determine that the document category is “undetermined” if the confidence score is less than a threshold, or if more than one category is associated with a confidence score higher than the threshold. In such examples, the document may be forwarded for manual processing.

At an operation 210, the process 200 may determine text segments in the document corresponding to fields in insurance records (e.g., loss report, insurance claim, insurance policy, etc.). In examples, each document category may be associated with a pre-defined list of potential fields e.g., a document category “repair estimate” may be associated with “vendor name,” “vendor address,” “estimated amount,” “owner name,” “vehicle make/model” etc. The process 200 may determine a correspondence between text segments of the document and one or more fields of the pre-defined list of potential fields corresponding to the category of the document. In some examples, the process 200 may determine the correspondence using a trained ML model or using characteristics of the text segments, as described in further detail with reference to FIGS. 3 and 4.

At an operation 212, the process 200 may populate unfilled fields in an existing digital record with values from the text segments corresponding to the respective fields, as determined at the operation 210. In examples, the process 200 may identify the digital record based on matching known field values of the digital record (e.g., participant name, vehicle make/model etc.) with corresponding text segment values from the document. For example, a text segment “John Smith” may be determined to be a “name” field (e.g., of the owner of a vehicle) and/or “J093405” may be determined to be a “VIN number” field (e.g., identifier of a specific vehicle) in the document. The process 200 may locate an insurance record e.g., an insurance claim, with a “participant name” field matching “John Smith” and/or a “VIN number” field matching “J093405,” thus identifying the insurance claim as being associated with the document. Accordingly, if a text segment “$475.60” in the document is determined to correspond to an “estimated amount” field, then the “estimated amount” field of the insurance claim may be populated with the amount “$475.60,” as discussed further with reference to an example in FIG. 4. In some examples, the process 200 may only populate fields where a confidence score of the correspondence higher than a threshold.

At an operation 214, the process 200 may determine one or more actions based on the document type, category and/or values corresponding to fields. As non-limiting examples, a document of “image type” and a scene class “kitchen” or “bathroom” received as an attachment to an email may be saved in association with an insurance policy of a home, where the insurance policy may be identified in the email, a document of category “medical bill” where a text segment corresponding to an “amount due” field is determined, may be assigned a high priority and forwarded to a payments processing system. In some examples, if the “amount due” value is higher than a threshold amount which may be based on the category (e.g., the threshold value for a “vehicle repair bill” category may be different from a “vehicle rental bill” category), the process 200 may determine further actions e.g., a review by a human agent. As another example, if the insurance record was awaiting the document to proceed to next steps (e.g., a loss report awaiting a document of category “police report”), notifications may be sent to claim handler(s) processing the insurance record informing them that the document has been received. Other actions based on the type, category, and/or value of fields are also envisaged, including examples provided throughout the disclosure. In some examples, a summary of the actions may be generated at the operation 214. For example, the summary may include the document category (e.g., “medical bill”), amount paid and reason (e.g., “$520.25” corresponding to a “medical code 413.2,”), date of payment, recipient of payment, etc.

FIG. 3 depicts an example process 300 for matching text segments with fields of an insurance record, and populating empty fields of the insurance record with values corresponding to the respective matching text segments. For example, some or all of the process 300 may be performed by the data field detection component in FIG. 1.

At an operation 302, the process 300 may include receiving text segment(s) extracted from a document of a known document category. The process 300 assumes that the document category corresponding to the document has been previously determined using techniques described herein. For example, the document category may be determined by providing, as input, the text segment(s) to a trained ML model configured to output a document category when provided with text as input, as described with respect to the category classification component 126 of FIG. 1.

At an operation 304, the process 300 may determine characteristics associated with the text segment(s). Non-limiting examples of characteristics include whether the text segment(s) is alphabetical or numerical, whether the text segment(s) corresponds to a date e.g., which may be determined based on detecting a date format or text corresponding to a name of month, whether the text segment(s) correspond to a proper noun such as a name of a person or a name of a business e.g., as indicated by capitalization, first name/last name format or text such as “Inc.,” “LLC” etc., whether the text segment(s) corresponds to a dollar (or other currency) amount e.g., which may be determined by a presence of a “$” sign and placement of a decimal point, whether the text segment corresponds to a license plate number or a VIN number of a vehicle e.g., as determined by a known number of letters and numbers, and the like.

At an operation 306, the process 300 may identify a field corresponding to the characteristics. In examples, the process 300 may access a pre-defined set of potential fields for the document category of the document. For example, a vehicle “repair estimate” document category may include the potential fields “repair shop,” “address of repair shop,” “vehicle make/model,” “participant name” (e.g., name of an insured person), “estimated amount,” “date of loss,” and the like. In examples, each named field may be associated with known characteristics. For example, a “participant” field may accept a person's name, an “estimated amount” field may accept a dollar amount, a “date of loss” field may accept a date, a “repair shop” field may accept a name of a business (e.g., a vendor providing vehicle repair services), and the like. In some examples, the process 300 may identify the field corresponding to the text segment(s) from the pre-defined set of potential fields by matching the characteristics of the text segment(s) with the known characteristics of the named fields. In other examples, the process 300 may identify the field corresponding to the text segment(s) by providing the text segment(s) as input to a trained ML model configured to output a field name corresponding to the inputted text, along with a confidence score. In some examples, the process 300 may access a lexicon of vendor names, addresses, policy holders, vehicle VIN numbers, etc. listing known entities of the insurance company to associate text segment(s) with field names.

At an operation 308, the process 300 may determine whether the identified field matches an empty field of an existing digital record. As an example, an insurance company may store various types of records such as insurance policies, insurance claims, loss reports etc. These records may be stored in a database or other data structure and may include information associated with participants of an insurance policy, information about insurance coverage, information about an incident causing loss or damage, information about parties associated with the loss, information related to a medical incident, expenses associated with the loss or medical incident, and the like. The digital records may have numerous fields e.g., a “participant” field corresponding to a person's name, a “amount due” field corresponding to a dollar amount, a “date of loss” field, a “rental company” field corresponding to a name of a vendor providing rental vehicles, and the like. In examples, some fields may already be populated with values, whereas some fields may be empty. For example, when an insurance claim record is initiated, it may have its “policy number” field, “participant” field, “vehicle make/model,” and “coverage amount” field populated using information from an insurance policy against which the insurance claim is filed, whereas fields such as “estimated amount”, “repair shop name”, “repair date”, “amount due”, etc. may be empty (e.g., no value is populated).

In examples, at the operation 308, the process 300 may identify the existing digital record associated with the document based on matching unique identifiers such as a value associated with a “participant” field, a “vehicle VIN number” field, or a “policy number” field, and the like in the document, with corresponding values in the existing record. If the identified field in the text segment(s) matches an empty field of the insurance record (at operation 308—Yes), the process 300, at an operation 312, determine if the confidence level of the match is higher than a threshold. In some examples, the confidence level may be determined as an output of a ML model configured to output a field identifier when provided with input text. In other examples, the confidence level may be based on other matches in the document. For example, if the values in text segment(s) corresponding to “participant” and “vehicle make/model” fields match the insurance record, the document category is a “repair estimate” and the text segment(s) received at the operation 302 is a dollar amount in the range $500-1000, then the process 300 may determine that the confidence level of the match with a “estimated amount” field is high. In another example, if a text segment corresponds to an “address” field, but the value of a state name in the address field does not match the home state listed the insurance record, then the text segment identified as matching “participant” may be of low confidence value e.g., the address may belong to a third-party claimant.

If the confidence level is higher than a threshold (at operation 312—Yes), the process 300, at an operation 314 may populate the empty field of the insurance record with the value identified in the text segment(s). If the confidence level is lower than or equal to the threshold (at operation 312-No) or if the identified field in the text segment(s) does not match an empty field of any insurance record (at operation 308-No), the process 300, at an operation 310 may take no further action on the text segment(s) and may move to processing the next text segment(s) in the document starting at operation 302.

FIG. 4 illustrates an example 400 of associating values in a received document with fields of an existing insurance record, which may use the process 300 shown in FIG. 3. In examples, the text segment(s) may be matched with fields using a trained ML model or using characteristics of the text segment(s) as described above.

In the example 400 shown, a text document 402 may include various text segments 404 that have been mapped to fields of a pre-defined set of fields associated with a category of the text document 402. For example, the category of the text document 402 may be a “vehicle repair bill,” where text segment(s) 404 (1, . . . , n, . . . . N) of the document 402 have been mapped to a “participant name” field 404(1), a “vehicle make/model” field 404(2), a “repair shop name” field 404(3), a “mailing address” field 404(n), and the like. In the example shown, a value of the “participant name” field 404(1) matches 406 a value of a “participant name” field 408(1) of an insurance record 410 (e.g., a loss report for an accident that has previously been submitted) that includes various fields 408 (1, . . . , m, . . . . M). In addition, a value in the “vehicle make/model” field 404(2) may also match a “vehicle make/model” field 408(2) of the insurance record 410, resulting in a high confidence score that the text document 402 is related to the insurance record 410. As a result of determining the matches 406, the process 300 may populate 412 a value in the “claim amount” field 404(n) into a “claim amount” field 408(m) of the insurance record 410, and a value in the “repair shop name” field 404(3) into a “repair shop name” field 408 (m+1) of the insurance record 410. In some examples, the process 300 may further associate the text document with other fields of the insurance record so that the text document can be searchable using values in the other fields. For example, the text document 402 may be associated 414 with a value in the “policy number” field 408(3) and a value in the “cause-of-loss” field 408(4) of the insurance record 410. In examples, indexing the text document 402 with the policy number and cause-of-loss enables a search on the policy number and/or the cause-of-loss to return the text document 402.

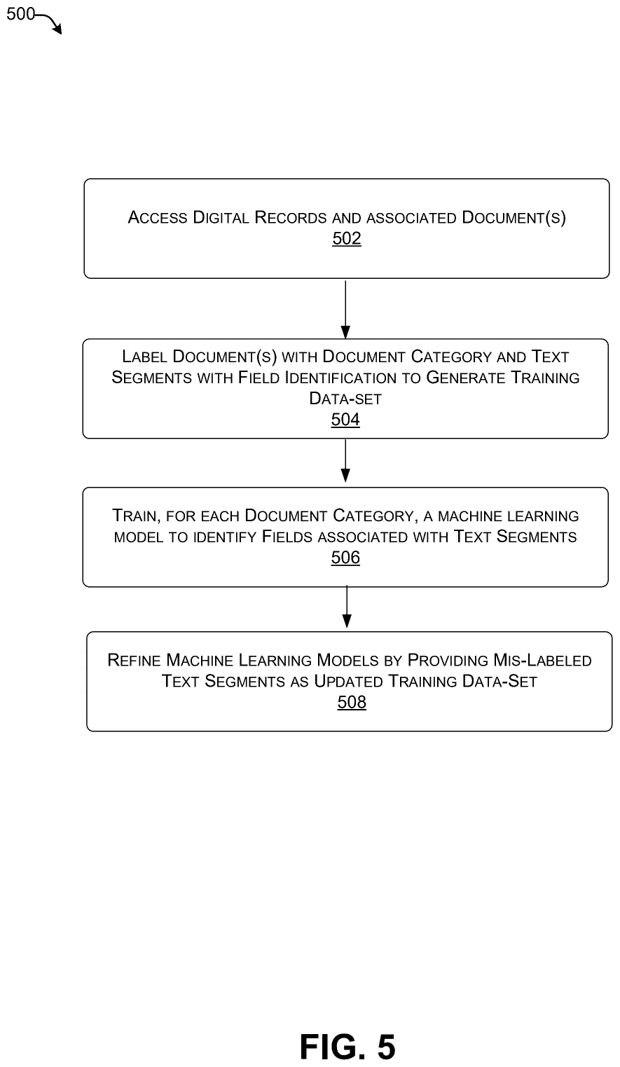

FIG. 5 illustrates an example process 500 for training and refining a machine learning (ML) model to label text segments with field identifiers, in accordance examples of this disclosure. The ML model may be trained using existing documents and insurance records of the insurance company.

At an operation 502, the process 500 may include accessing existing digital records and associated document(s) of the insurance company. The digital records may include insurance claims, insurance policies, loss reports, etc. The document(s) may be received documents from the various sources described with reference to FIG. 1.

At an operation 504, the process 500 may include labeling each document with a document category, and text segments within the document with identification of corresponding fields in the digital records to generate a training data-set. For example, each document may be labeled with a document category such as a “repair estimate,” “medical bill,” “police report,” etc. from a pre-defined list of document categories. In examples, each document category may also be associated with a potential list of fields that may occur in documents of the particular document category corresponding to fields in the digital records. The potential list of fields may also be generated from a large number of documents of the particular document category that have been previously labeled with fields corresponding to text segments in the documents. For example, text segments in a document of “rental bill” category may be identified with a “participant name” field, a “claim amount” field, a “rental company name” field, a “from date” field, a “to date” field, etc. In some examples, the labels and field identification may be applied manually or semi-automatically. For example, a user interface may provide field identification choices for each text segment based on characteristics of the text segment as described with respect to FIG. 3, allowing a human operator to easily select a field identification for a text segment. In some examples, the field identification choices may be ranked by confidence level. The labeled documents may form a training data-set for training a ML model using supervised learning techniques.

At operation 506, the process 500 may include training, for each document category, a ML model to identify fields associated with text segments. In examples, the text segments may be provided as inputs to the ML model and the corresponding field identification provided as an expected output. Weights of the ML model may be iteratively adjusted (e.g., using a backpropagation algorithm) until the prediction accuracy (e.g., percentage of output field identifications that match the corresponding label in the training data-set) of the ML model on the training data-set reaches a threshold level. The ML model, after training, is ready to receive text segments from new received documents as input and generate, as output, field identification corresponding to the input text. In examples, the ML model may also generate a confidence score corresponding to the output.

At operation 508, the process 500 may include refining the trained ML models by providing mis-labeled text segments as updated training data-set. During operations using the trained ML models, if text segments are detected in wrong fields of digital records due to mis-labeling of the text segments by the trained ML models, such text segments may be flagged e.g., by a human operator, and labeled with a correct field identification. The flagged text segments may be added to the training data-set to create an updated training data-set, and the ML models may be re-trained periodically with the updated training data-set to improve performance of the trained ML models over time.

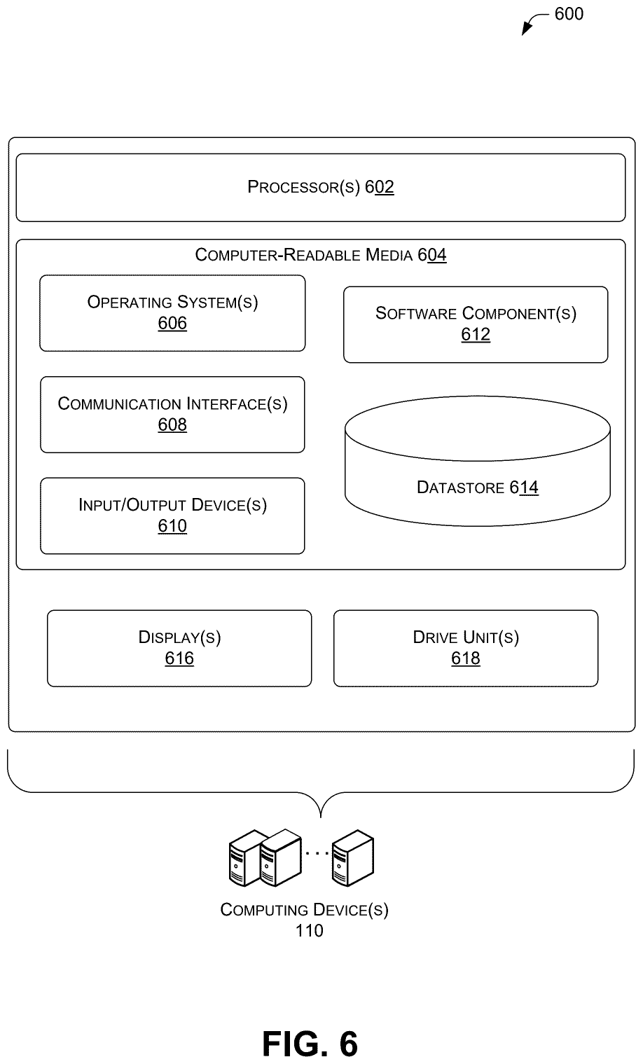

FIG. 6 is a block diagram of an illustrative computing architecture 600 of the computing device(s) 110 implementing techniques of the present disclosure. The computing architecture 600 may each be implemented in a distributed or non-distributed computing environment.

The computing architecture 600 may include one or more processors 602 and one or more computer-readable media 604 that stores various components, applications, programs, or other data. The computer-readable media 604 may include instructions that, when executed by the one or more processors 602, cause the processors to perform the operations described herein for the system 100.

In various examples, the processor(s) 602 can be a central processing unit (CPU), a graphics processing unit (GPU), both a CPU and a GPU, or any other type of processing unit. Each of the processor(s) 602 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 602 may also be responsible for executing computer applications stored in the computer-readable media (or memory) 604.

The computer-readable media 604 may include non-transitory computer-readable storage media, which may include hard drives, floppy diskettes, optical disks, CD-ROMs, DVDs, read-only memories (ROMs), random access memories (RAMs), EPROMs, EEPROMs, flash memory, magnetic or optical cards, solid-state memory devices, or other types of storage media appropriate for storing electronic instructions. In addition, in some examples the computer-readable media 604 may include a transitory computer-readable signal (in compressed or uncompressed form). Examples of computer-readable signals, whether modulated using a carrier or not, include, but are not limited to, signals that a computer system hosting or running a computer program may be configured to access, including signals downloaded through the Internet or other networks. The order in which the operations are described is not intended to be construed as a limitation, and any number of the described operations may be combined in any order and/or in parallel to implement the process. Furthermore, the operations described below may be implemented on a single device or multiple devices.

As shown in FIG. 6, in some configurations, the computer-readable media 604 may store an operating system 606, one or more communication interface(s) 608, one or more input/output (I/O) interface(s) 610, and a datastore 614, which are described in turn. The components may be stored together or in a distributed arrangement. The operating system 606 may enable control and management of various functions of the computing device(s) 110, as described herein.

The communication interface(s) 608 may include one or more interfaces and hardware components for enabling communication with various other devices, such as over the network(s) 108 or directly. For example, communication interface(s) 608 may enable communication through the network(s) 108, which can include, but are not limited any type of network known in the art, such as a local area network or a wide area network, such as the Internet, and can include a wireless network, such as a cellular network, a local wireless network, such as Wi-Fi and/or close-range wireless communications, such as Bluetooth®, BLE, NFC, RFID, a wired network, or any other such network, or any combination thereof. Accordingly, the network(s) 108 may include both wired and/or wireless communication technologies, including Bluetooth®, BLE, Wi-Fi and cellular communication technologies, as well as wired or fiber optic technologies. Components used for such communications can depend at least in part upon the type of network, the environment selected, or both. Protocols for communicating over such networks are well known and will not be discussed herein in detail.

The computing architecture 600 may further include the one or more I/O devices 610. Input devices of I/O devices 610 can include any sort of input devices known in the art e.g., a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism. Output devices if the I/O devices 610 can include any sort of output devices known in the art, such as a display, speakers, a vibrating mechanism, and/or a tactile feedback mechanism. The I/O devices 610 can also include ports for one or more peripheral devices, such as headphones, peripheral speakers, and/or a peripheral display.

The computer-readable media 604 can store software component(s) 612 corresponding to the components 112-130 of the document intake system 102 and the components 140-144 of the document handling system 138, and/or other elements described herein. Additionally, or alternately, the software component(s) 612 can include any other components that can be utilized by the document intake system 102 or the document handling system 138 to perform or enable performing any actions described herein. Such other components can include a platform, operating system, and applications, and data utilized by the platform, operating system, and applications.

In examples, the software component(s) 612 may access data from the datastore 614 and/or store results in the datastore 614. For example, the datastore 614 may store insurance records of the insurance company, and the software component(s) 612 may access the datastore 614 to access insurance records associated with the document(s) 104. The datastore 614 may also store lexicons related to the pre-defined list of significant words and/or fields associated with various document categories. Additionally, the software component(s) 612 may store results of performing actions in the datastore 614 e.g., document summarization results, data field detection results, category classification results, etc. In some examples, the ML model(s) 132 and/or the training data-set(s) 136 may be stored in the datastore 614.

The computing devices 110 can also have displays 616 and/or a drive unit 618. The display 616 can be a liquid crystal display or any other type of display commonly used in computing devices. For example, a display 616 may be a touch-sensitive display screen, and can then also act as an input device or keypad, such as for providing a soft-key keyboard, navigation buttons, or any other type of input. The drive unit 618 may include machine readable medium storing one or more sets of instructions, such as software or firmware, that embodies any one or more of the methodologies or functions described herein.

Although the subject matter has been described in language specific to structural features and/or methodological acts, it is to be understood that the subject matter is not necessarily limited to the specific features or acts described above. Rather, the specific features and acts described above are disclosed as example embodiments.

What is claimed is:

1. A method comprising:
receiving, by a processor, an electronic document, the electronic document including text data;
extracting, by the processor and using text recognition, the text data from the electronic document;
inputting, by the processor, the text data to a machine-learning (ML) model, wherein the ML model is trained to receive text data as input and to output a document category that corresponds to the input;
receiving, by the processor, as output from the ML model and based at least in part on the text data, an indication of a particular document category corresponding to the electronic document;
identifying, by the processor and based on the particular document category, a text segment of the text data, the text segment characterized by text features;
determining, by the processor and based on the text features, a data field of a claim processing system corresponding to the text segment; and
associating, by the processor, the text segment with the data field.

2. The method of claim 1, wherein the ML model is a first ML model, and determining the data field comprises:
selecting, by the processor and based on the particular document category, a second machine-learning (ML) model from a plurality of ML models, each model of the plurality of ML models being trained using text data associated with a respective document category;
inputting, by the processor, the text segment to the second ML model, the second ML model being trained to receive text data as input, and output identification of a corresponding data field; and
receiving, by the processor, as output from the second ML model, the data field corresponding to the text segment.

3. The method of claim 1, wherein the text segment is a first text segment, the method further comprising:
determining, by the processor and from the text data, a second text segment indicative of a particular digital record of the claim processing system;
determining, by the processor, that a first data field of the particular digital record matching the data field corresponding to the first text segment is empty; and
inserting, by the processor, the first text segment as a value of the first data field in the particular digital record.

4. The method of claim 3, further comprising:
determining, by the processor, a second data field of the particular digital record identifying the particular digital record; and
associating, by the processor, a value of the second data field with the electronic document.

5. The method of claim 1, wherein the electronic document is a first electronic document and the ML model is a first ML model, the method further comprising:
receiving, by the processor, a second electronic document;
invoking, by the processor, a second machine learning (ML) model configured to determine a type of an electronic document,
wherein the type identifies the electronic document as one of an image type or a text type;
determining, by the processor and based on an output of the second ML model, that the second electronic document is of the image type; and
based on determining that the second electronic document is of the image type, determining, by the processor and using a third ML model configured to output a scene class corresponding to an input image, a scene class corresponding to the second electronic document.

6. The method of claim 5, wherein the scene class comprises one of: a kitchen, a living room, a bathroom, a building exterior, a vehicle exterior, a vehicle interior, or an aerial scene.

7. The method of claim 5, further comprising:
determining, by the processor and based on the scene class, a label associated with the second electronic document;
determining, by the processor, a digital record of the claim processing system associated with the second electronic document; and
associating, by the processor, the digital record with a link to a storage location of the second electronic document and the label.

8. The method of claim 1, further comprising:
determining, by the processor and based at least in part on the particular document category, an action to be performed with the electronic document,
wherein the action comprises at least one of:
associating the electronic document with a priority level,
setting permissions of the electronic document to allow the electronic document to be externally viewable,
routing the electronic document to a destination for further processing,
updating a dashboard to indicate receipt of the electronic document, or
linking the electronic document to an digital record of the claim processing system.

9. The method of claim 1, wherein the ML model:
comprises a set of category-specific ML models, each category-specific model of the set of category-specific ML models being configured to output:
a binary determination of whether an input document corresponds to a respective document category, and
an associated confidence score,
provides, as input, to each category-specific model of the set of category-specific ML models, the text data, and
generates, as output, the respective document category determined by a category-specific ML model, the category-specific ML model associated with a highest confidence score of the set of category-specific ML models.

10. The method of claim 1, wherein the document category comprises one of: a repair estimate, a repair bill, a medical bill, a medical treatment estimate, a vehicle rental bill, a tow bill, a police report or an attorney demand package.

11. The method of claim 1, wherein the data field comprises one of: name of a policy participant, policy number, cause-of-loss code, name of a vendor, an address of the vendor, claim amount, estimated amount, vehicle make and model, or date of loss.

12. A system, comprising:
a processor; and
memory storing computer-executable instructions that, when executed by the processor, cause the processor to perform operations comprising:
receiving an electronic document including text data;
extracting, from the electronic document and using optical character recognition (OCR), the text data;
invoking a machine-learning (ML) model trained to determine a document category, wherein said invoking comprises:
providing, as input, the text data to the ML model, and
receiving, as output, a particular document category based on the text data;
determining text features corresponding to a text segment of the text data;
identifying, based on the particular document category, a set of pre-defined fields characterized by respective field features;
determining, based on comparing the text features with the field features, a first field of the set of pre-defined fields, wherein the respective field features of the first field matches the text features; and
associating with the text segment an identification of the first field.

13. The system of claim 12, wherein the ML model is trained using a training data-set, the operations further comprising:
determining that the particular document category received as the output of the ML model does not match an actual document category of the electronic document;
based on determining that the particular document category received as the output of the ML model does not match the actual document category, augmenting the training data-set to include the text data and the actual document category; and
training the ML model with the augmented training data-set.

14. The system of claim 12, wherein the text features comprise at least one of: a length of the text segment, whether the text segment is alphabetical or numerical, whether the text segment denotes a proper noun, whether the text segment denotes a calendar date, or whether the text segment denotes a mailing address.

15. The system of claim 12, the operations further comprising:
determining, based at least in part on the particular document category and the text segment, an action to be performed with the electronic document,
wherein the action comprises at least one of:
associating the electronic document with a priority level,
updating a dashboard to indicate the particular document category associated with the electronic document, or
linking the electronic document to a digital record of a claim processing system.

16. The system of claim 12, wherein the text segment is a first text segment, the operations further comprising:
determining, from the text data, a second text segment indicative of a particular digital record of a claim processing system;
determining that a second field of the particular digital record is empty, the respective field features of the second field matching text features of the second text segment; and
inserting the second text segment as a value of the second field in the particular digital record.

17. A non-transitory computer-readable medium storing instructions which, when executed by a processor, cause the processor to:
receive an electronic document;
determine that the electronic document includes text data;
extract, using text recognition, the text data from the electronic document;
determine, using a machine-learning (ML) model trained to receive text data as input, and output a document category, a particular document category corresponding to the electronic document;
identify, based on the particular document category, a set of data fields associated with the particular document category in a claim processing system;
determine, based on text features, a text segment of the text data corresponding to a data field of the set of data fields; and
associate the text segment with the data field.

18. The non-transitory computer-readable medium of claim 17, wherein the text features comprise at least one of:
a length of the text segment,
whether the text segment is purely alphabetical,
whether the text segment is purely numerical,
whether the text segment matches a known format of a data field, or
whether the text segment denotes a proper noun.

19. The non-transitory computer-readable medium of claim 17, wherein the instructions further cause the processor to:
identify, based on the text data, an existing digital record of the claim processing system; and
determine, as a value of the data field, a value represented by the text segment.

20. The non-transitory computer-readable medium of claim 19, wherein the instructions further cause the processor to:
determine, based at least in part on the particular document category and the text segment, an action to be performed with the electronic document, wherein the action comprises at least one of:
associating the electronic document with a priority level,
setting permissions of the electronic document to allow the electronic document to be externally viewable,
routing the electronic document to a destination for further processing, or
linking the electronic document to the digital record.
